(19) United States
(12) Patent Application Publication
(10) Pub. No.: US 2012/0198126 A1
(43) Pub. Date: Aug. 2, 2012

(54) METHODS AND SYSTEMS FOR PERFORMING SELECTIVE BLOCK SWITCHING TO PERFORM READ OPERATIONS IN A NON-VOLATILE MEMORY

(75) Inventors: Daniel J. Post, Campbell, CA (US); Matthew Byom, Campbell, CA (US)

(73) Assignee: Apple Inc., Cupertino, CA (US)

(21) Appl. No.: 13/015,746

(22) Filed: Jan. 28, 2011

(51) Int. Cl. G06F 12/00

(52) U.S. Cl. 711/103; 711/E12.008

(57) ABSTRACT

Systems and methods are disclosed for increasing efficiency of read operations by minimizing the number of block switching events necessary to read each page associated with a read command. According to embodiments of this invention, for any given block containing one or more pages that need to be read for a read command, each of those one or more pages is read before switching to another block, thereby eliminating potential time penalties in switching between blocks. A block switching module according to embodiments of the invention instructs a NVM controller to read all relevant pages out of a given block even if an original read order sequence of the pages to be read would otherwise normally cause NVM controller to switch to another block.

### BACKGROUND OF THE DISCLOSURE

NAND flash memory, as well as other types of non-volatile memory (“NVM”), is commonly used in electronic devices for mass storage. For example, consumer electronics such as portable media players often include flash memory to store music, videos, and other media. During use of these electronics, the file system can issue a read command that requests several relatively small “chunks” of data to be read from NVM. These data chunks may be distributed across the NVM and arranged in a read sequence that may not be amenable to efficient die level read operations. Accordingly, systems and methods for increasing efficiency of NVM operations are needed.

### SUMMARY OF THE DISCLOSURE

Systems and methods are disclosed for increasing efficiency of read operations by minimizing the number of block switching events necessary to read each page associated with a read command. According to embodiments of this invention, for any given block containing one or more pages that need to be read for a read command, each of those one or more pages is read before switching to another block, thereby eliminating potential time penalties in switching between blocks. A block switching module according to embodiments of the invention instructs a NVM controller to read all relevant pages out of a given block even if an original read order sequence of the pages to be read would otherwise normally cause NVM controller to switch to another block.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 is an illustrative block diagram of a system in accordance with various embodiments of the invention;

FIG. 2 is an illustrative block diagram showing in more detail a portion of a NVM package in accordance with an embodiment of the invention;

FIG. 3 shows an illustrative block diagram of NVM in accordance with an embodiment of the invention;

FIG. 4 shows an illustrative block diagram of NVM having pages numbered according to an order as provided by a file system issued read command;

FIG. 5 shows an illustrative graphs of block switching events in accordance with an embodiment of the invention;

FIG. 6 is an illustrative flow chart of process steps that may be performed to re-arrange the order in which pages are read from NVM in accordance with an embodiment of the invention; and

FIG. 7 illustrates a process for minimizing the number of block switch events necessary to read all pages for a given read command in accordance with an embodiment of the invention.

### DETAILED DESCRIPTION OF THE DISCLOSURE

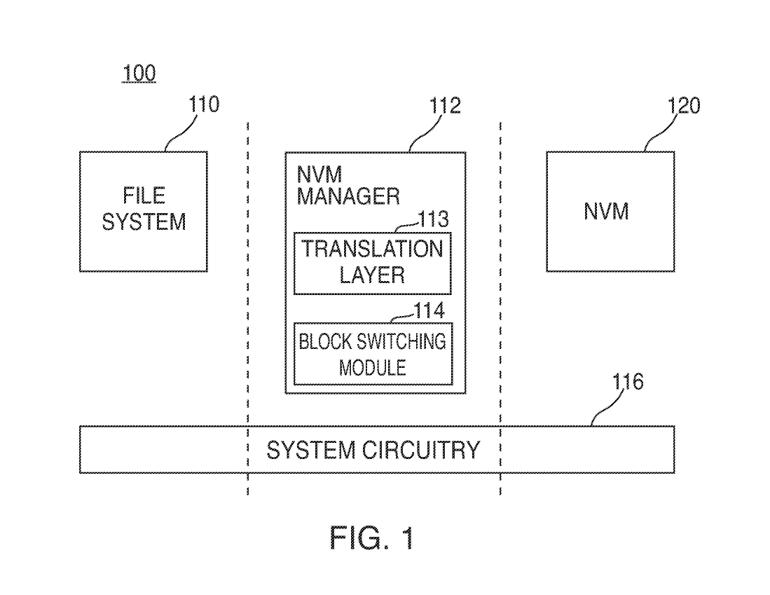

FIG. 1 illustrates a block diagram of a combination of firmware, software, and hardware components of system 100 in accordance with an embodiment of the invention. System 100 can include file system 110, NVM manager 112, system circuitry 116, and NVM 120. In some embodiments, file system 110 and NVM manager 112 may represent various software or firmware modules, and system circuitry 116 may represent hardware.

System circuitry 116 may include any suitable combination of processors, microprocessors, memory (e.g., DRAM), or hardware-based components (e.g., ASICs) to provide a platform on which firmware and software operations may be performed. In addition, system circuitry 116 may include NVM controller circuitry for communicating with NMV 120, and in particular for managing and/or accessing the physical memory locations of NVM 120. Memory management and access functions that may be performed by the NVM controller can include issuing read, write, or erase instructions and performing wear leveling, bad block management, garbage collection, logical-to-physical address mapping, SLC or MLC programming decisions, applying error correction or detection, and data queuing to set up program operations.

In one embodiment, NVM controller circuitry can be implemented as part of a “host” side of system 100. Host side NVM controllers may be used when NVM 120 is “raw NVM” or NVM having limited or no controller functionality. As used herein, “raw NVM” may refer to a memory device or package that may be managed entirely by a controller external to the NVM package. NVM having limited or no controller functionality can include hardware to perform, for example, error code correction, but does not perform memory management functions.

In another embodiment, the NVM controller circuitry can be implemented by circuitry included as part of the package that constitutes NVM 120. That is, the package can include the combination of the NVM controller and raw NVM. Examples of such packages include USB thumbdrives and SDcards.

NVM 120 can include NAND flash memory based on floating gate or charge trapping technology, NOR flash memory, erasable programmable read only memory (“EPROM”), electrically erasable programmable read only memory (“EEPROM”), Ferroelectric RAM (“FRAM”), magnetoresistive RAM (“MRAM”), or any combination thereof. NVM 120 can be organized into “blocks”, which is the smallest erasable unit, and further organized into “pages”, which can be the smallest unit that can be programmed or read. In some embodiments, NVM 120 can include multiple dies, where each die may have multiple blocks. The blocks from corresponding die (e.g., blocks having the same position or block number) may form “super blocks”. Each memory location (e.g., page or block) of NVM 120 can be addressed using a physical address (e.g., a physical page address or physical block address).

In some embodiments, the memory density of NVM 120 can be maximized using multi-level cell technology. MLC technology, in contrast to single level cell (“SLC”) technology, has two or more bits per cell. Each cell is commonly referred to as a page, and in a two-bit MLC NAND, for example, a page is split into an upper page and a lower page. The upper page corresponds to the higher order bit and the lower page corresponds to the lower order bit. Due to device physics, data can be read out of lower pages faster than upper pages.

File system 110 can include any suitable type of file system, such as a File Allocation Table (“FAT”) file system or a Hierarchical File System Plus (“HFS+”). File system 110 can manage file and folder structures required for system 100 to function. File system 110 may provide write and read commands to NVM manager 112 when an application or operating system requests that information be read from or stored in NVM 120. Along with each read or write command, file system 110 can provide a logical address indicating where the data should be read from or written to, such as a logical page address or a LBA with a page offset.

File system 110 may provide read and write requests to NVM manager 112 that are not directly compatible with NVM 120. For example, the LBAs may use conventions or protocols typical of hard-drive-based systems. A hard-drive-based system, unlike flash memory, can overwrite a memory location without first performing a block erase. Moreover, hard drives may not need wear leveling to increase the lifespan of the device. Therefore, NVM manager 112 can perform any functions that are memory-specific, vendor-specific, or both to handle file system requests and perform other management functions in a manner suitable for NVM 120.

NVM manager 112 can include translation layer 113 and block switching module 114. In some embodiments, translation layer 113 may be or include a flash translation layer (“FTL”). On a write command, translation layer 113 can map the provided logical address to a free, erased physical location on NVM 120. On a read command, translation layer 113 can use the provided logical address to determine the physical address at which the requested data is stored. For example, translation layer 113 can be accessed to determine whether a given LBA corresponds to a lower page or an upper page of NVM 120. Because each NVM may have a different layout depending on the size or vendor of the NVM, this mapping operation may be memory and/or vendor-specific. Translation layer 113 can perform any other suitable functions in addition to logical-to-physical address mapping. For example, translation layer 113 can perform any of the other functions that may be typical of flash translation layers, such as garbage collection and wear leveling.

Block switching module 114 may be operative to re-order the sequence in which pages are to be read out of NVM 120. As will be explained in more detail below, for a given read sequence, it can be more efficient to read all pages from a given block (included in the read sequence) before instructing the NVM hardware to switch to another block to read additional pages included in the read sequence, as opposed to switching to whatever block that contains the page(s) that need to be read next according to the read sequence. Block switching module 114 may process a read command, which includes LBAs corresponding to pages located in at least two different blocks, received from file system 110 and determine the best order to read those pages read out of NVM 120. Block switching module 114 may maintain overhead needed to accommodate the re-ordering of the sequence in which pages are read out the NVM.

NVM manager 112 may interface with a NVM controller (included as part of system circuitry 116) to complete NVM access commands (e.g., program, read, and erase commands). The NVM controller may act as the hardware interface to NVM 120, and can communicate with NVM package 120 using the bus protocol, data rate, and other specifications of NVM 120.

NVM manager 112 may manage NVM 120 based on memory management data, sometimes referred to herein as “metadata”. The metadata may be generated by NVM manager 112 or may be generated by a module operating under the control of NVM manager 112. For example, metadata can include any information used for managing the mapping between logical and physical addresses, bad block management, wear leveling, ECC data used for detecting or correcting data errors, markers used for journaling transactions, or any combination thereof.

The metadata may include data provided by file system 110 along with the user data, such as a logical address. Thus, in general, “metadata” may refer to any information about or relating to user data or used generally to manage the operation and memory locations of a non-volatile memory. NVM manager 112 may be configured to store metadata in NVM 120.

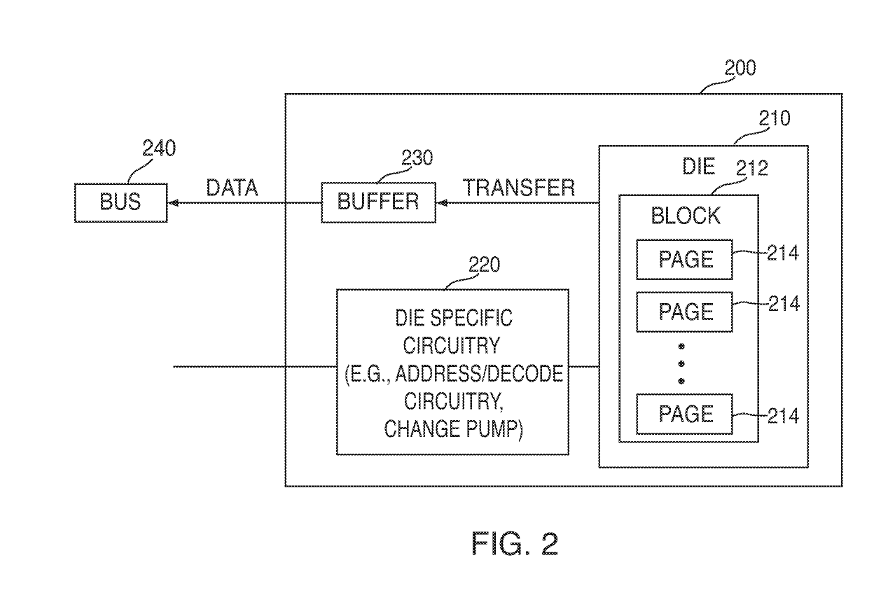

FIG. 2 is an illustrative block diagram showing in more detail a portion of NVM package 200 in accordance with an embodiment of the invention. NVM package 200 can include die 210, buffer 220, and die specific circuitry 230. Die 210 can include a predetermined number of physical blocks 212 and each block can include a predetermined number of pages 214. In some embodiments, pages 214 include upper and lower pages. Pages and blocks represent physical locations of memory cells within die 210. Cells within the pages or blocks can be accessed using die specific circuitry 220.

Die specific circuitry 220 can include circuitry pertinent to the electrical operation of die 210. For example, circuitry 220 can include circuitry such as row and column decode circuitry to access a particular page and charge pump circuitry to provide requisite voltage needed for a read, program, or erase operation. Die specific circuitry 220 is usually separate and distinct from any circuitry that performs management of the NVM (e.g., such as NVM manager 112 of FIG. 1) or any hardware generally associated with a host.

Buffer 230 can be any suitable structure for temporarily storing data. For example, buffer 230 may be a register. Buffer 230 may be used as an intermediary for transferring data between die 210 and bus 240. There are timing parameters associated with how long it takes for data to be transferred between bus 240 and buffer 230, and between buffer 220 and die 210. The timing parameters discussed herein are discussed in reference to read operations.

A read operation can include two parts: (1) a buffer operation, which is a transfer of data read from die 210 to buffer 230, and (2) a bus transfer operation, which is a transfer of data from buffer 230 to bus 240. Both operations have a time component. The buffering operation and the time required to fully perform it are referred to herein as Tbuff. The bus transfer operation and the time required to fully perform it are referred to herein as Txbus.

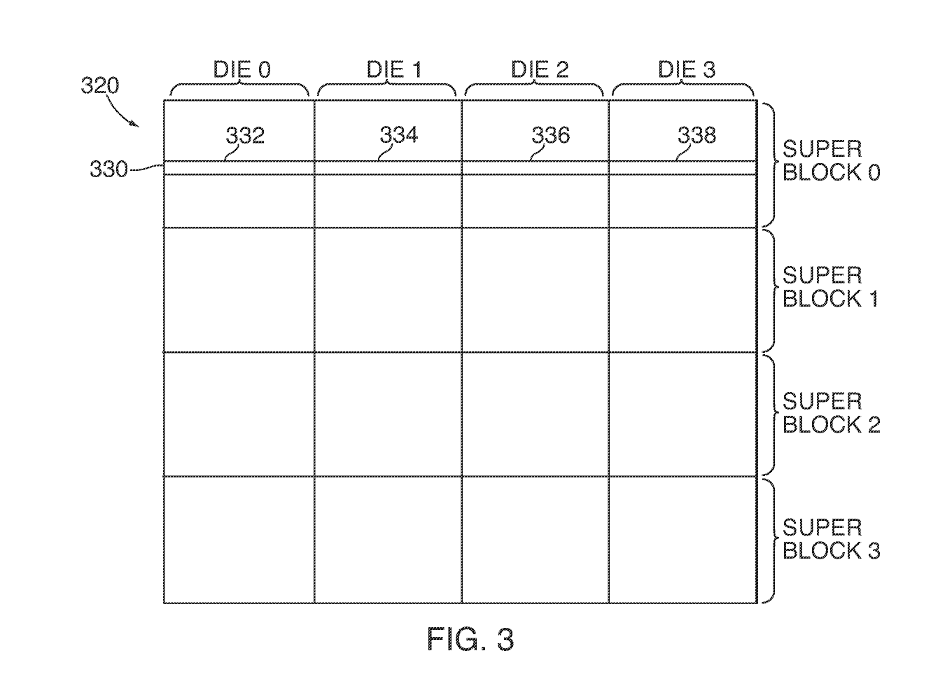

As mentioned above, a non-volatile memory (e.g., NVM 120 of FIG. 1), can be organized into dies, blocks, pages, super blocks, and the like. For example, FIG. 3 shows an illustrative block diagram of NVM 320. FIG. 3 is merely meant to illustrate the organizational layout of NVM 320 and do not indicate an actual, physical layout of the non-volatile memory. For example, although die 0 is illustrated as being next to die 1 in FIG. 3, this is merely for illustrating the functional relationship of these dies, and in the actual, physical layout of NVM 320, these dies may or may not be located near one another. Moreover, although a certain number of dies, blocks, and pages are shown in FIG. 3, this is merely for the purpose of illustration and one skilled in the art could appreciate that NVM 320 could include any suitable number of dies, blocks, and pages. NVM 320 can be single level cell (SLC) NVM, multi-level cell (MLC) NVM, or a combination of both SLC and MLC NVM.

As illustrated by FIG. 3, NVM 320 can include one or more dies, such as die 0, die 1, die 2, and die 3. Each die may then be organized into one or more “blocks.” For example, die 0 is illustrated as being organized into blocks 0-3. During an erase command of NVM 320, an entire block of memory may be erased at once. Each block of the dies may then be organized into one or more pages. For example, block 0 of die 2 (e.g., block 302), is illustrated as being organized into pages 0-3. During a read or write command of NVM 320, a full page may be read or written at once, respectively. NVM 320 can also include one or more super blocks that include one block from each die. For example, super block 0 of NVM 320 can include block 0 of each of dies 0-3. Similarly, super block 1 of NVM 320 can include block 1 of each of dies 0-3, super block 2 of NVM 320 can include block 2 of each of dies 0-3, and so forth.

Each die may be accessed simultaneously. Thus, when data is either written to or read from NVM 320, a “stripe” of data can be written or read. A “stripe” can include a page from each of one or more dies. For example, FIG. 3 shows stripe 330 of NVM 320. Stripe 330 can include the same page number of each of dies 1-3 of super block 0. During operation of NVM 320, the pages of a stripe and/or super block may be sequentially processed. For example, during a read or write operation of stripe 330, page 332 may be processed, followed by the processing of page 334, then followed by the processing of page 336, and then followed by the processing of page 338.

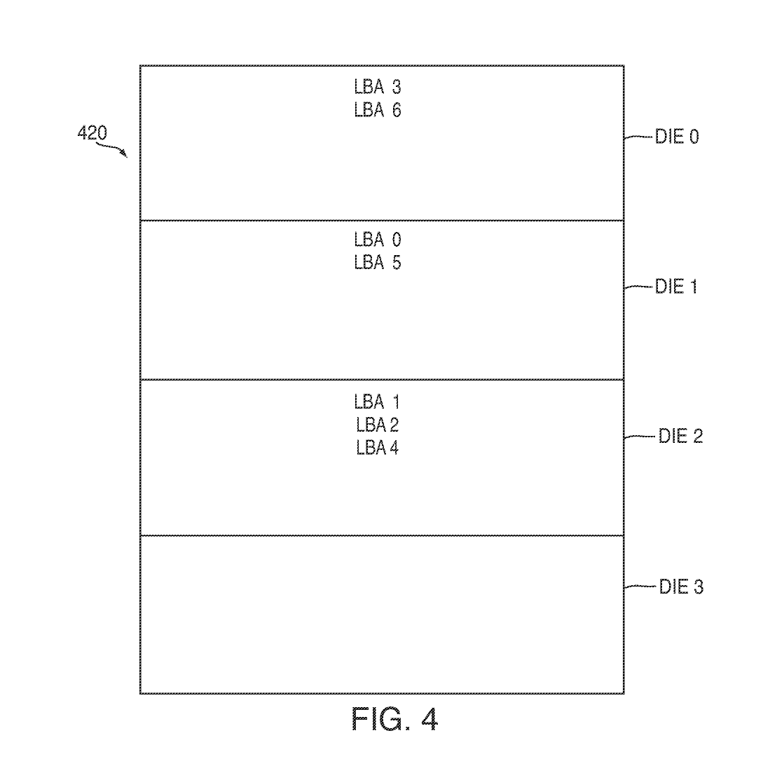

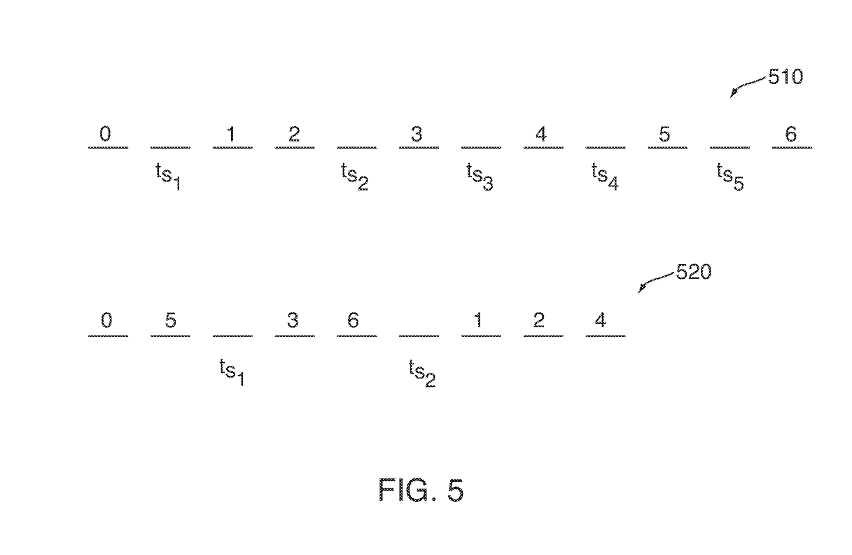

FIG. 4 shows an illustrative block diagram of NVM 420 having pages numbered according to an order as provided by a file system issued read command. That is, a file system (e.g., file system 110) can issue a read command including LBAs that translate to pages that are distributed across multiple blocks or superblocks. More particularly, the read command includes LBAs that translate to pages contained in at least two blocks and at least two of those blocks include at least two pages that need be read. Thus, in a conventional approach, when the NVM manager (e.g., NVM manager 112) passes instructions down to the NVM controller to read the pages in LBA sequence order, the NVM controller may first read LBA 0 (from block 1), switch to block 1 to read LBAs 1 and 2, switch to block 0 to read LBA 3, and so on. Block switching graph 510 of FIG. 5 shows the LBA read order sequence and the block switching events, tₛ₁₋₅, for the LBAs shows in FIG. 4. As shown in graph 510, five block switching events are required to read all the LBAs in the original read order sequence. Inefficiency exists in this approach when the NVM controller switches to another block to read a page even though the block it was reading before switching had at least one other page included in the read order sequence

This inefficiency is eliminated using a block switching module according to an embodiment of the invention. Using this module, the order in which the pages are read is re-arranged to minimize the number of block switches needed to read all the pages included in the read order sequence. In effect, the order in which the pages are read is re-arranged so that each page is read out of a given block before switching to another block. Referring to FIG. 4, the block switching module can, for example, re-arrange the read sequence of LBAs 0, 1, 2, 3, 4, 5 and 6 such that LBAs 0 and 5 are read from block 1, and LBAs 3 and 6 are read from block 0, and LBAs 1, 2, and 4 are read from block 2. As shown in graph 520 of FIG. 5, only two block switching events are needed to read all the LBAs included in the read order sequence.

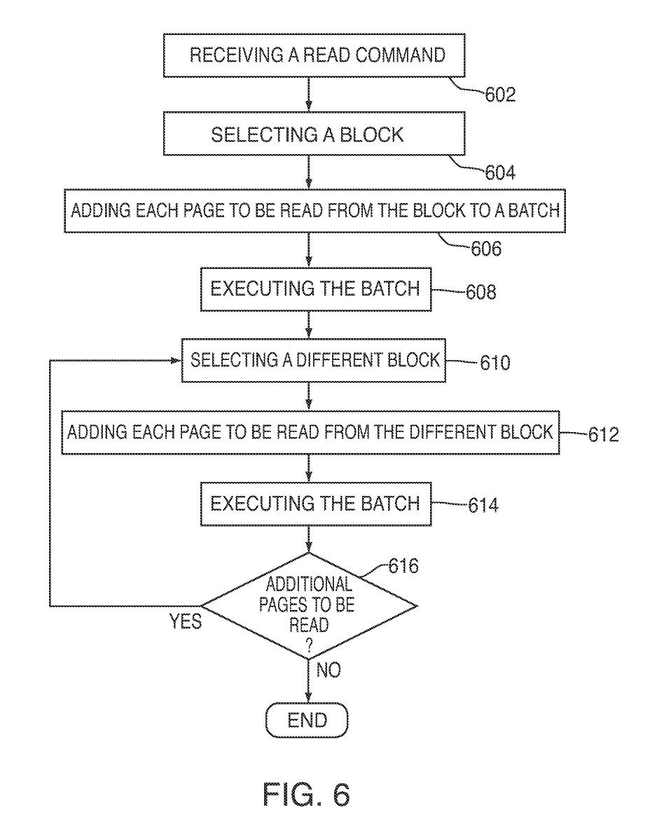

FIG. 6 is an illustrative flow chart of process steps that may be performed to re-arrange the order in which pages are read from NVM in accordance with an embodiment of the invention. Beginning with step 602, a read command is received. The read command may include an original sequence of LBAs to be retrieved from the NVM. The LBAs are translated to the physical location of pages. Depending on the translation layer used, the LBA may be mapped directly to a page or the LBA may be mapped to a block with page offset.

At step 604, a block is selected. The block can be selected based on any suitable number of criteria, but each selected block includes a page from the original read sequence. The selected block can be based on a random selection of any page in the read order sequence or the “first in line” page of the read order sequence. Another criteria for selecting a block can be based on the number of pages that need to be read out of a given block.

At step 606, each page, included in the read sequence, that can be read from the selected block is added to a batch. The batch is an accumulation of pages packaged into an instruction that is provided to the NVM controller. The NVM controller, in response to receiving the batch instruction, executes the instruction by reading the batched pages out of NVM (step 608).

At step 610, a different block is selected. The same criteria used to selected a block in step 602 may be applied to select the different block. At step 612, each page, included in the read sequence, that can be read from the selected different block is added to a batch. At step 614, the batch is executed and those pages are read out of NVM.

At step 616, a determination is made whether any additional pages need to be read (from the read sequence). If the determination is YES, the process returns to step 610, and if the determination is NO, the process ends.

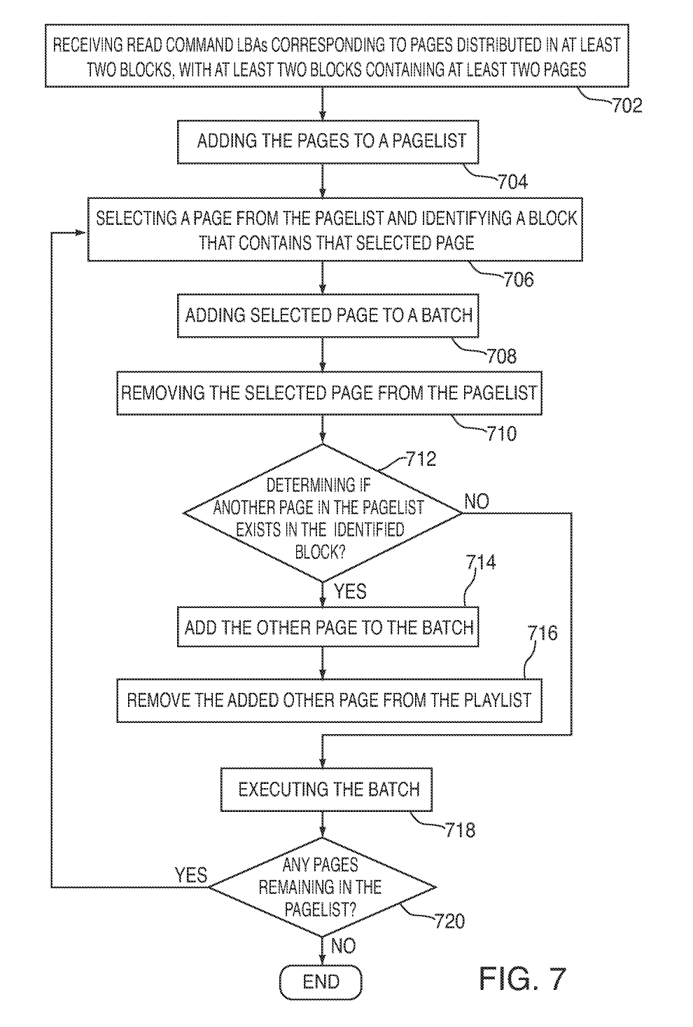

FIG. 7 illustrates a process for minimizing the number of block switch events necessary to read all pages for a given read command in accordance with an embodiment of the invention. Beginning at step 702, a read command is received. The read command can include LBAs corresponding to pages distributed in at least two blocks, with at least two blocks containing at least two pages. At step 704, the pages are added to a pagelist. The pagelist includes a list of pages that need to be read out of NVM, but have not yet been included in a batch instruction.

At step 706, a page is selected from the pagelist, and by association, a block including that selected page is identified. At step 708, the selected page is added to a batch, and at step 710, the selected page removed from the pagelist. At step 712, a determination is made if another page in the pagelist is contained in the identified block. If the determination at step 712 is YES, the process proceeds to step 714.

At step 714, the other page is added to the batch and at step 716 that other page is removed from the page list. After step 716, the process returns to step 712. If the determination at step 712 is NO, the process proceeds to step 718, which executes the batch.

Then, at step 720, a determination is made whether any pages remain in the pagelist. If the determination is YES, the process reverts to step 706. If the determination is NO, the process ends.

It should be understood that the steps included in flowcharts of FIGS. 6 and 7 are merely illustrative. Any of the steps may be removed, modified, or combined, and any additional steps may be added, without departing from the scope of the invention.

The described embodiments of the invention are presented for the purpose of illustration and not of limitation.

What is claimed is:

1. A method comprising:
receiving a read command, the read command including logical block addresses (LBAs) that correspond to a plurality of pages in non-volatile memory (NVM);
adding the plurality of pages to a pagelist data structure;
selecting one of the pages from the pagelist for inclusion in a batch, wherein a block including the selected page is identified;
determining if another page in the pagelist exists in the identified block;
adding the other page to the batch if it is determined that the other page in the pagelist exists in the identified block;
executing the batch when no other pages in the pagelist exist in the identified block.

2. The method of claim 1, further comprising:
removing the selected page from the pagelist.

3. The method of claim 1, further comprising:
removing the other page determined to exist in the identified block from the pagelist.

4. The method of claim 1, wherein the other page added to the batch is the first other page, the method further comprising:
determining if at least a second other page in the pagelist exists in the identified block; and
adding the at least a second other page to the batch if it is determined that the second other page exists in the identified block.

5. The method of claim 1, further comprising:
determining if the pagelist is empty;
if the pagelist is not empty:
selecting one of the pages from the pagelist for inclusion in a second batch, wherein a block including the selected page is identified as a second identified block;
adding all pages in the pagelist that exist in the identified second block to the second batch;
executing the second batch when no other pages in the pagelist exist in the identified second block.

6. The method of claim 1, wherein during execution of the batch, the NVM switches to the identified block, and during execution of the second batch, the NVM switches to the identified second block.

7. The method of claim 1, wherein the non-volatile memory is nand flash memory.

8. The method of claim 1, wherein the block is a physical block in NVM.

9. The method of claim 1, wherein the block is a superblock.

10. A system comprising:
non-volatile memory (“NVM”) comprising a plurality of dies, each die having a plurality of blocks each including a plurality of pages;
a NVM manager operative to communicate with the NVM, the NVM manager operative to:
receive a read command to read a plurality of pages;
maintain a pagelist of the plurality of pages to be read;
selectively add one or more of the pages maintained in the pagelist to a batch, wherein each page added to the batch is included in the same first block.

11. The system of claim 10, wherein the NVM manager is operative to:
remove any page added to the batch from the pagelist.

12. The system of claim 10, wherein the NVM manager is operative to:
instruct the NVM to read the pages in the batch after determining that no additional pages from the pagelist exist in the same first block.

13. The system of claim 10, wherein the batch is a first batch, and wherein the NVM manager is operative to:
selectively add one or more of the pages maintained in the pagelist to a second batch, wherein each page added to the second batch is included in the same second block.

14. The system of claim 13, wherein the NVM manager is operative to read pages included in the first batch from the same first block before switching to the second block to read pages include in the second block.

15. A method implemented in a system comprising non-volatile memory (“NVM”) having a plurality of blocks, the method comprising:
receiving a read command to read a plurality of pages dispersed throughout the NVM;
selecting a first block;
adding each page included to the first block to a first batch;
executing the first batch;
selecting a second block;
adding each page included in the second block to a second batch; and
executing the second batch.

16. The method of claim 15, wherein an original read order sequence of the pages to be read would not result in a minimal number of block switching events to read all the pages if read in the original read order sequence.

17. The method of claim 15, wherein the first block is randomly selected based on the pages to be read.

18. The method of claim 15, further comprising:
selecting a third block;
adding each page included in the third block to a third batch; and
executing the third batch.
